(19) United States
(12) Patent Application Publication
(10) Pub. No.: US 2007/0047001 A1
(43) Pub. Date: Mar. 1, 2007

(54) Reduction of image artifacts in digital printing

(76) Inventors: Ilan Blaus, Nordiya (IL); David Nacash, Kfar Yona (IL)

Correspondence Address: Mark G. Bocchetti;Patent Legal Staff, Eastman Kodak Company, 343 State Street, Rochester, NY, 14650-2201, US

(21) Appl. No.: 11/216,949

(22) Filed: Aug. 31, 2005

(51) Int. Cl. G06T 5/00

(52) U.S. Cl. 358/3.26

(57) ABSTRACT

An apparatus and method of reducing image artifacts on ink coverage areas of a lithographic printing plate are provided. The method includes providing digital image data including ink coverage pixel values; reducing the ink coverage pixel values by a predetermined amount by applying a transformation to the digital image data; and imaging a printing plate using the transformed digital image data. The apparatus includes a processor operable to apply a transformation to received digital image data to reduce ink coverage pixel values included in the digital image data by a predetermined amount; and an imaging device operable to image a printing plate using the transformed digital image data with the imaging device being in electrical communication with the processor.

### FIELD OF THE INVENTION

This invention relates generally to the printing industry, and in particular to reducing or eliminating printed image artifacts created during a printing plate imaging process.

### BACKGROUND OF THE INVENTION

A printed image scattered with image artifacts or printing defects, commonly referred to as “hickeys” or “silhouettes”, caused by loosened debris interfering with the imaging of printing plates is a known problematic phenomenon in the printing industry. This problem is readily apparent when imaging digital printing plates having a large image area, for example, an area having 100% ink coverage (known as a solid area) or having a very high ink-coverage percentage (known as a shadows area), both being referred to hereinafter as a solid area(s). The phase and the magnitude of the problem depend on the plate type, imaging characteristics, plate-cleaning technique, or a combination of these factors.

Loosened debris originates in the plate imaging stage, off-press or on-press, when large or small chunks or particles (hereinafter referred to as debris) break away or fly loose from an imaged area of the printing plate during imaging and/or cleaning of the printing plate. The likelihood of this happening increases when imaging and/or cleaning a solid area of the printing plate. The presence of this debris causes artifacts on the printed image and often results in unacceptable low printing quality, unexpected waste, inefficient production, and high maintenance and service costs. The debris may additionally cause unpredictable contamination of the imaging device or the printing press and thus prevent continuous operation and production. This problematic phenomenon can be discerned on the imaged plate or within the imaging device or within the printing press, prior to printing with the printing plate.

Referring to FIGS. 1, 2, and 3, top views of a printing plate 10 are shown. In FIG. 1, printing plate 10 is shown before cleaning and includes a solid area 15 imaged thereon and a non-imaged area 50. In FIG. 2, printing plate 10 is shown after cleaning and includes a solid area 20 imaged thereon and a non-imaged area 50. No “silhouettes” are discerned in solid area 20. In FIG. 3, printing plate 10 is shown after cleaning and includes solid area 20 imaged thereon and non-imaged area 50. “Silhouettes” 30 are present in solid area 20.

Some of the ways in which “silhouettes” can be created will now be discussed.

Printing plates that are ablated during the imaging process typically have an oleophilic or oleophobic top layer coating. The top layer differentiates between ink-accepting and ink-rejecting areas on the printing plate. A typical oleophobic material for a top layer is silicone. However, other types of materials can be used for either the oleophilic or oleophobic top layer.

The ablation of imaged areas is accomplished by heat generated during the plate imaging process, causing the top layer, e.g. silicone, to “explode” in selective areas, in accordance with the image to be printed. The debris from the ablated plate has to be removed by a cleaning device, so as to end up with distinct ink-accepting and ink-rejecting areas. Various mechanical plate cleaning techniques are known in the industry. These include, for example, cleaning with a rotating brush, rubbing with an elastomeric roller, vacuum suction, and wiping the plate with a cleaning fluid.

The cleaning techniques described above can be used in plate cleaning devices when the plate is imaged off press as is known in the industry or in offset presses that have on-press imaging systems or heads, for example, the KBA 74 Karat, commercially available from Koenig & Bauer AG, Würzburg, Germany. When using an on-press imaging device, the plate is sequentially imaged and printed on the same machine without having to unload the plate after it has been imaged and reload the plate onto a plate cylinder of a press for printing.

There are several ways in which loosened debris can be created when imaging, for example, a solid area of a printing plate, when imaging is performed either off-press or on-press. For example, loose debris can be created during imaging of the plate. Debris loosened by the imaging process can lodge between the imaging head and the printing plate hiding areas to be imaged from the imaging head and thus causing areas of the printing plate to be improperly imaged. Loose debris can be created during imaging and simultaneous cleaning of the plate. Debris loosened by the cleaning process can lodge between the imaging head and the printing plate hiding areas to be imaged from the imaging head and thus causing areas to be improperly imaged. Loose debris can be created after imaging is complete without or prior to cleaning. Debris loosened by the imaging process can fly loose due to the continuing rotation of the drum causing air turbulence inside the imaging device. The debris can fly all over the imaging device or the printing press (when using an on-press imaging device) causing unpredictable contamination. Loose debris can be created during cleaning of the plate after imaging of the plate has been completed. Debris loosened by the cleaning process can fly loose all over the imaging device or the printing press (when using an on-press imaging device) causing unpredictable contamination.

In FIG. 4a, printing plate 10 is shown before cleaning and includes a solid area 15 imaged thereon and a non-imaged area 50. Printing plate 10 also includes top layer 25, for example, silicone, as shown in FIGS. 4a and 4b. In FIGS. 4a and 4c, top layer 25 has been loosened by one or a combination of imaging, rolling, and/or folding operations causing imaged area 17 to be revealed. Portions of top layer 25 can detach and fly off contaminating other areas of the plate or press or be folded so as to hide neighboring and yet un-imaged area(s) 50 of the printing plate 10 from the imaging system. A prior-art tone reproduction curve useable to produce solid area 15 on printing plate 10 is shown in FIG. 5a. End-point 40 shows a transformation of a 100% digital file data ink dot or pixel coverage value to a 100% ink dot or pixel coverage value.

When using off-press and on-press imaging techniques, increased productivity can be achieved by reducing or even eliminating unpredictable contamination of the imaging device and/or the printing press caused by loosened debris. During the imaging and/or cleaning of solid areas of a printing plate, debris can fly loose onto the plate loading mechanism, the imaging head, the inking system, or any other part of the imaging and/or printing paths. The loosened debris can at least partially eliminate the transfer of ink onto the printed recording medium and/or interrupt production schedules by causing malfunctions in the subsequent press print job(s).

In both off-press and on-press imaging techniques, productivity can be enhanced by eliminating unnecessary sequential operations. For example, the imaging and cleaning operations can be performed simultaneously. When this is done, a debris-suction cleaning operation can be performed on an imaged swath or area of a printing plate in parallel with the imaging operation of the next swath or area of the printing plate. However, this highly desired mode of operation is prone to creating “silhouettes” on the imaged printing plate. When imaging solid areas of the printing plate, this problem is readily evident as the particles of debris tend to detach from the plate's top layer and evade the suction cleaning mechanism during the cleaning process. At least some of the particles fly off and land on still un-imaged areas of the plate causing that portion of the plate to be hidden from the imaging system.

Attempts have been made to eliminate image artifacts, commonly referred to as “hickeys” or “silhouettes”, using mechanical devices, see, for example, U.S. Pat. No. 6,672,206 B2, issued on Jan. 6, 2004, to Villarreal;

U.S. Pat. No. 6,827,015 B2, issued on Dec. 7, 2004, to Villarreal; and U.S. Pat. No. 6,457,412 B1, issued on Oct. 1, 2002, to Jones. Creo Inc., Vancouver, Canada, has implemented a solution that involves hardware logic that observes all data sent to an imaging head in order to identify series of consecutive ON pixels numbering N (pre-defined) plus a small random number. When such a sequence is identified, the next pixel is set to be OFF, regardless of its original value. This solution helps to avoid solid areas when imaging a printing plate which in turn helps to reduce or even eliminate image artifacts, commonly referred to as “hickeys” or “silhouettes”.

However, there is still a need to reduce or even eliminate image artifacts, commonly referred to as “hickeys” or “silhouettes”, in both off-press and on-press plate imaging operations when plate cleaning is accomplished either on-the fly or following plate imaging.

### SUMMARY OF THE INVENTION

According to one aspect of the present invention, a method of reducing image artifacts on ink coverage areas of a lithographic printing plate is provided. The method includes providing digital image data including ink coverage pixel values; reducing the ink coverage pixel values by a predetermined amount by applying a transformation to the digital image data; and imaging a printing plate using the transformed digital image data.

According to another aspect of the present invention, an apparatus for reducing image artifacts in ink coverage areas of a lithographic printing plate is provided. The apparatus includes a processor operable to apply a transformation to received digital image data to reduce ink coverage pixel values included in the digital image data by a predetermined amount. An imaging device is in electrical communication with the processor and is operable to image a printing plate using the transformed digital image data.

### BRIEF DESCRIPTION OF THE DRAWINGS

In the detailed description of the preferred embodiments of the invention presented below, reference is made to the accompanying drawings, in which:

FIG. 1 is a schematic top view of a prior art printing plate with a solid area imaged thereon;

FIG. 2 is a schematic top view of a prior art printing plate with a solid area imaged thereon, after cleaning, without “silhouettes”;

FIG. 3 is a schematic top view of a prior art printing plate with a solid area imaged thereon, after cleaning, with “silhouettes”;

FIG. 4a is a schematic top view of a prior art printing plate with a solid area imaged thereon, before cleaning, showing loosened debris;

FIG. 4b is a schematic side view of a prior art printing plate with a solid layer imaged thereon, before cleaning, showing a top layer;

FIG. 4c is a schematic side view of a prior art printing plate with a solid area imaged thereon, before cleaning, showing loosened debris;

FIG. 5a shows a prior-art tone reproduction curve used to create an imaged area on a printing plate;

FIG. 5b shows a tone reproduction curve according to one example embodiment of the present invention;

FIG. 6 is a schematic representation of a digital front-end system driving an imaging system.

FIG. 7a is a schematic top view of a printing plate with a solid area imaged thereon made in accordance with the present invention, before cleaning;

FIG. 7b is a schematic side view of a printing plate with a solid area imaged thereon made in accordance with the present invention, before cleaning; and

FIG. 7c is a schematic top view of a printing plate with a solid area imaged thereon made in accordance with the present invention, after cleaning.

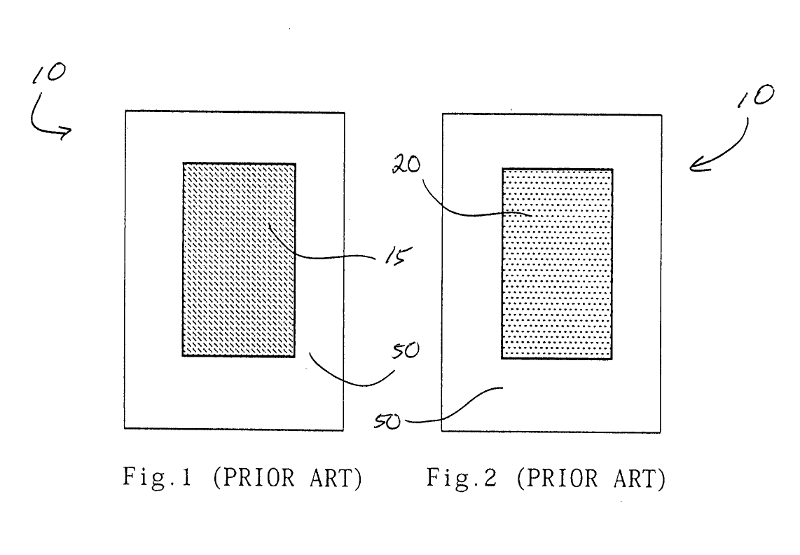

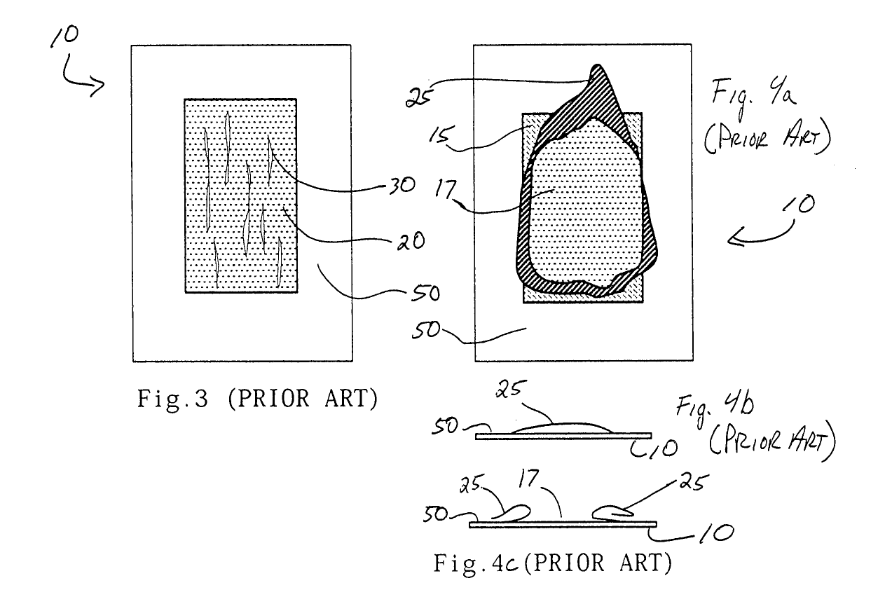

### DETAILED DESCRIPTION OF THE INVENTION

The present description will be directed in particular to elements forming part of, or cooperating more directly with, apparatus and method in accordance with the present invention. It is to be understood that elements not specifically shown or described may take various forms well known to those skilled in the art.

The solution provided by the present invention uses data processing techniques rather than mechanical means to reduce or even eliminate printed image artifacts or defects created during a printing plate imaging process. A processor is used to transform a solid area(s) as defined by digital data file ink dot or pixel coverage values to a lower ink-coverage area by transforming the high digital data file ink dot or pixel coverage values of the solid area(s) to screen values with a lower dot or pixel coverage percent. The transformation can be performed by the processor in advance, prior to imaging of the plate, or on the fly, during the imaging of the plate.

The inventors have found out that by changing the original dot or pixel coverage values of the digital data file at top end-points problems associated with “hickeys” or “silhouettes” are reduced or even eliminated. Doing this forms non-solid areas scattered with non-imaged dots, a pixel or pixels, on the printing plate. Non-imaged dots reduce the likelihood or even prevent debris from detaching and flying off from the printing plate by securing the top layer of the printing plate to the plate substrate. The problem associated with “hickeys” or “silhouettes” is overcome or managed while the dot gain of the printing press compensates for the non-imaged dots making the area appear solid on the printed recording medium.

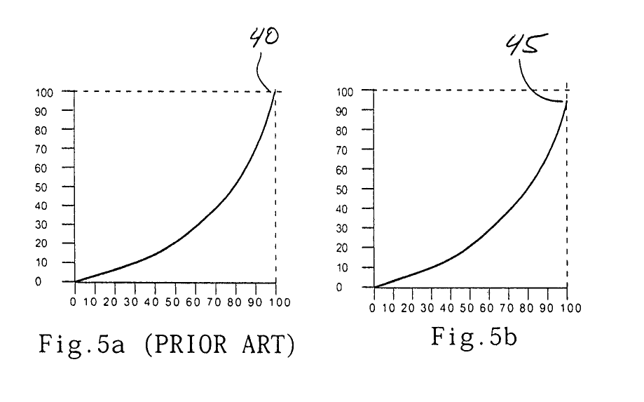

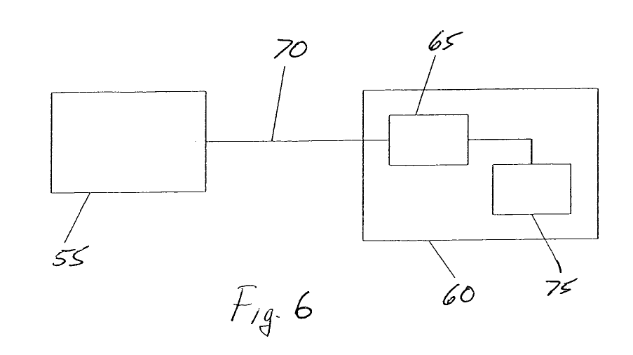

In FIG. 5b one example embodiment of the present invention is shown. A tone reproduction curve useable to produce a solid area on a printing plate is shown. However, end-point 45 has been transformed such that a 100% digital data file ink dot or pixel coverage value has a lower ink dot or pixel coverage value (or screen) when compared to the prior art tone reproduction curve shown in FIG. 5a.

A digital front end (DFE) system, for example, a Brisque system, commercially available from Eastman Kodak Co., Rochester, N.Y., is programmed to process or perform the transformation in advance during digital data file preparation at the prepress area. Alternatively, a controller of the imaging device is programmed to process or perform the transformation on-the-fly. Hardware, software, or a combination of both can be used to perform the transformation. As such, the DFE system and/or the imaging device controller include hardware, software, or a combination of both in order to accomplish the method of the invention.

In FIG. 6, a schematic representation of a digital front-end system 55 driving an imaging system 60 is shown. DFE system 55 is electrically connected with imaging system 60 by connecting means 70, for example, a data bus or any other communication means known in the industry. Imaging system 60 includes a controller 65 in electrical communication with an imaging system 75. Controller 65 receives digital data to be imaged from digital front-end system 55 and sends that data to imaging system 75. Imaging system 60 can be any on-press imaging system or off-press imaging system known in the industry.

In another example embodiment of the present invention, the change to the percent ink dot or pixel coverage value can be achieved by specifically modifying the percentage either in the digital data file prior to applying the tone reproduction curve, during imaging, or during imaging after applying the tone reproduction curve. This embodiment can also be accomplished using software, hardware, or a combination of both, and processed or performed by the DFE system 55 and/or the imaging system controller 65.

Application of the transformation to the data to be imaged can be accomplished in several modes of operation. For example, the transformation can be applied to the data off-line during data preparation at the prepress area. When this is done, DFE system 55 can apply the transformation to the digital data file values of solid areas and save the transformed data file for subsequent imaging. Alternatively, the transformation can be applied on-the-fly during imaging. When this is done, controller 65 can apply the transformation to the digital data file values of solid areas during imaging.

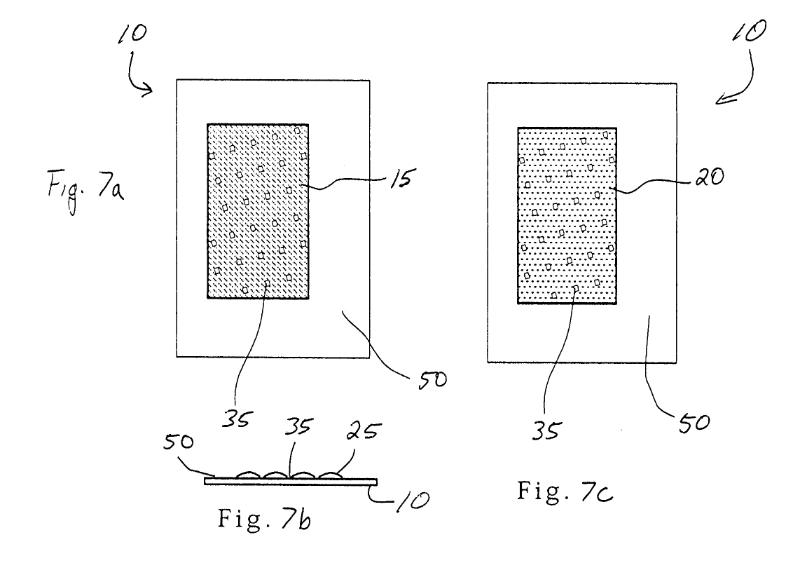

In FIGS. 7a and 7b, a printing plate 10 with a solid area 15 imaged thereon according to the present invention, before cleaning, is shown. Top-layer 25 is intact and elements 35 denoting un-imaged spots, a pixel or pixels, created by imaging of printing plate 10 using a dot or pixel coverage percent of less than 100%. Printing plate 10 also includes a non-imaged area 50. In FIG. 7c, a printing plate 10 with a solid area 20 imaged thereon according to the present invention, after cleaning, in shown. Printing plate 10 also includes a non-imaged area 50. Again, elements 35 denote un-imaged spots, a pixel or pixels, created by imaging of printing plate 10 using a dot or pixel coverage percent of less than 100%.

The implementation of the present invention overcomes the problem associated with “hickeys” or “silhouettes” described above and is applicable to at least off-press and on-press imaged ablation printing plates imaged and cleaned sequentially or in parallel. Additionally, the printing plates can be either waterless, water-based, or a combination of both.

Specific examples of the present invention will now be discussed. The inventors have found that transforming end-points having a 100% digital data file including ink dot or pixel coverage value to end-points having 97% to 98% ink dot or pixel coverage value yields acceptable results. The inventors have also found that transforming end-points having less than a 100% digital data file including ink dot or pixel coverage value by reducing ink dot or pixel coverage values by 1%-3% yields acceptable results.

However, the best results can vary according to at least plate type, imaging characteristics, plate-cleaning technique, and/or a combination of these factors. As such, the specific percentage associated with ink dot or pixel coverage value reduction when the transformation is performed will vary depending on the specifics of the application contemplated. In this sense, the amount of ink dot or pixel coverage value reduction is predetermined.

The invention has been described in detail with particular reference to certain preferred embodiments thereof, but it will be understood that variations and modifications can be effected within the scope of the invention.

1. A method of reducing image artifacts on ink coverage areas of a lithographic printing plate, the method comprising:
providing digital image data including ink coverage pixel values;
reducing the ink coverage pixel values by a predetermined amount by applying a transformation to the digital image data; and
imaging a printing plate using the transformed digital image data.

2. The method of claim 1, wherein the predetermined amount is selected based on a percentage of ink coverage pixel values.

3. The method of claim 2, wherein the ink coverage pixel values include 100% ink coverage pixel values.

4. The method of claim 3, wherein the predetermined amount is between 2% to 3%.

5. The method of claim 2, wherein the ink coverage pixel values include ink coverage pixel values less than 100%.

6. The method of claim 5, wherein the predetermined amount is between 1% to 3%.

7. The method of claim 1, wherein applying the transformation to the digital image data comprises applying the transformation to the digital image data prior to imaging the printing plate.

8. The method of claim 1, wherein applying the transformation to the digital image data comprises applying the transformation to the digital image data while imaging the printing plate.

9. The method of claim 1, the transformation comprising a tone-reproduction curve having a top end-point, wherein applying the transformation to the digital image data comprises changing the top end-point of the tone-reproduction curve.

10. The method of claim 1, wherein imaging the printing plate comprises off-press imaging of the printing plate.

11. The method of claim 1, wherein imaging the printing plate comprises on-press imaging of the printing plate.

12. A printing plate imaged using the method of claim 1.

13. An apparatus for reducing image artifacts in ink coverage areas of a lithographic printing plate, the apparatus comprising:
a processor operable to apply a transformation to received digital image data to reduce ink coverage pixel values included in the digital image data by a predetermined amount; and
an imaging device operable to image a printing plate using the transformed digital image data, the imaging device being in electrical communication with the processor.

14. The apparatus of claim 13, wherein the processor is operable to apply the transformation prior to the imaging device being operable.

15. The apparatus of claim 14, wherein the processor is included in a digital front end (DFE) system.

16. The apparatus of claim 13, the imaging device including a controller, wherein the processor is located in the controller of the imaging device and is operable to apply the transformation when the imaging device is operable.

17. The apparatus of claim 13, wherein the imaging device is an on-press imaging device.

18. The apparatus of claim 13, the transformation comprising a tone-reproduction curve having a top end-point, wherein the processor is operable to apply the transformation to the digital image data by changing the top end-point of the tone-reproduction curve.

19. The apparatus of claim 13, wherein the predetermined amount is selected by the processor based on a percentage of ink coverage pixel values.

20. The apparatus of claim 19, wherein the ink coverage pixel values include 100% ink coverage pixel values.

21. The apparatus of claim 20, wherein the predetermined amount is between 2% to 3%.

22. The apparatus of claim 19, wherein the ink coverage pixel values include ink coverage pixel values less than 100%.

23. The apparatus of claim 22, wherein the predetermined amount is between 1% to 3%.

24. The apparatus of claim 13, further comprising:
a storage device operable to store the digital image data, the storage device being in electrical communication with the processor.

25. A printing plate imaged by the apparatus of claim 13.
